(19) United States
(12) Patent Application Publication
(10) Pub. No.: US 2015/0187216 A1
(43) Pub. Date: Jul. 2, 2015

(54) AUTONOMOUS DRIVING VEHICLE AND INFRASTRUCTURE FOR SUPPORTING AUTONOMOUS DRIVING THEREOF

(71) Applicant: ELECTRONICS AND TELECOMMUNICATIONS RESEARCH INSTITUTE, Daejeon (KR)

(72) Inventor: Dong Yong KWAK, Daejeon (KR)

(73) Assignee: ELECTRONICS AND TELECOMMUNICATIONS RESEARCH INSTITUTE, Daejeon (KR)

(21) Appl. No.: 14/305,508

(22) Filed: Jun. 16, 2014

(30) Foreign Application Priority Data
Dec. 26, 2013 (KR) 10-2013-0164061

(51) Int. Cl. G08G 1/16; G08G 1/09

(52) U.S. Cl. CPC G08G 1/164; G08G 1/091

(57) ABSTRACT

Provided is an autonomous driving vehicle, and an infrastructure for supporting autonomous driving thereof. The autonomous driving vehicle of the present invention receives information obtained by converging sensor information (for example, infrastructure sensor information and traffic information) based on an infrastructure and vehicle sensor information selected by the infrastructure from the infrastructure positioned at the outside. Accordingly, the autonomous driving vehicle of the present invention may overcome a limitation of vehicle-based autonomous driving, thereby improving obstacle avoidance performance, solving inaccuracy of a sensor, and decreasing frequent setting of a path.

### CROSS-REFERENCE TO RELATED APPLICATION

This application is based on and claims priority from Korean Patent Application No. 10-2013-0164061, filed on Dec. 26, 2013, with the Korean Intellectual Property Office, the disclosure of which is incorporated herein in its entirety by reference.

### BACKGROUND

1. Field

The present invention relates to an autonomous driving system, and more particularly to, an autonomous driving vehicle of which an information obtainment range for a surrounding environment of a vehicle is improved, and an infrastructure for supporting autonomous driving thereof.

2. Discussion of Related Art

A general autonomous driving vehicle performs autonomous driving through recognition and determination of a surrounding environment through various sensors attached to a vehicle without support of an external infrastructure. The autonomous driving vehicle has been developed while depending on various sensors mounted in order to recognize driving. However, an actual driving environment of a road is very complex, recognition ranges of the sensors mounted in the vehicles are limited, and the mounted sensors have a reliability problem, so that the autonomous driving technology dependent on only the sensors mounted in the vehicle has a limitation.

For example, when the vehicle autonomously drives a congested crossroad, a vehicle based autonomous driving technology of recognizing a traffic signal, such as traffic lights, recognizing a vehicle positioned at a blind spot, and performing autonomous driving through comprehensive determination has a limitation.

Further, when a driving path is set while being dependent to only short distance driving data, an operation of setting a driving path according to a state change in an obstacle generated at a distance, which the sensor may recognize, or over is frequently generated.

As described above, a vehicle based autonomous driving function by the sensor and the like mounted in the vehicle has a limitation. Accordingly, the vehicle based autonomous driving function has a problem in that a path is frequently set due to avoidance of an obstacle by a complex road environment, inaccurate data of the sensor, and a limitation of a recognition distance for recognizing a driving condition.

### SUMMARY

The present invention has been made in an effort to provide an autonomous driving vehicle for overcoming a limitation of vehicle based autonomous driving, and an infrastructure for supporting autonomous driving thereof.

Further, the present invention has been made in an effort to provide an autonomous driving vehicle capable of improving obstacle avoidance performance, solving inaccuracy of a sensor, and decreasing frequent path setting.

An embodiment of the present invention provides an autonomous driving vehicle, including: a communication unit configured to communicate with an infrastructure; a vehicle sensor information obtaining unit configured to obtain vehicle sensor information; an infrastructure driving information processing unit configured to provide the infrastructure with the vehicle sensor information through the communication unit when the vehicle sensor information is requested, and receive vehicle sensor information from a vehicle pre-selected by the infrastructure and object information generated based on information based on the infrastructure from the infrastructure through the communication unit; and an autonomous driving unit configured to receive the object information to control autonomous driving.

In the present exemplary embodiment, the infrastructure driving information processing unit may include: a vehicle sensor information providing module configured to receive a vehicle sensor information request from the infrastructure, and provide the vehicle sensor information according to the vehicle sensor information request; an infrastructure information synchronizing module configured to receive the object information, classify the object information according to time and a position, and maintain newest updated information; and an infrastructure information providing module configured to provide the autonomous driving unit with the object information.

In the present exemplary embodiment, the information based on the infrastructure may include traffic information and infrastructure sensor information, and the traffic information may include traffic condition information obtained through a traffic center and traffic light state information obtained through a traffic light control device, and the infrastructure sensor information includes information obtained by sensing surrounding environments of sensors connected with the infrastructure.

In the present exemplary embodiment, the infrastructure information synchronizing module may classify the object information according to time and a position, and maintain only newest information closest to current time based on the object information classified according to the time and the position.

An embodiment of the present invention provides an infrastructure for supporting autonomous driving of an autonomous driving vehicle, including: a communication unit configured to communicate with a plurality of vehicles; an infrastructure sensor information obtaining unit configured to obtain infrastructure sensor information obtained by sensing surrounding environments from a plurality of infrastructure sensors; a traffic information collecting unit configured to collect traffic information; and an infrastructure based driving condition recognizing unit configured to receive vehicle sensor information from a selected vehicle through the communication unit, synchronize the vehicle sensor information, the infrastructure sensor information, and the traffic information, and then provide the autonomous driving vehicle with object information generated based on the synchronized information through the communication unit.

In the present exemplary embodiment, the plurality of sensors may include at least one of a laser scanner, a vision sensor, and a radar.

In the present exemplary embodiment, the infrastructure based driving condition recognizing unit may include: a sensor information synchronizing module configured to synchronize the vehicle sensor information, the infrastructure sensor information, the traffic information based on time and a position; an object recognizing module configured to classify objects by using the synchronized information and generate object information by using the classified objects; and a driving condition information transmitting module configured to provide the autonomous driving vehicle with the object information through the communication unit.

In the present exemplary embodiment, the infrastructure based driving condition recognizing unit may further include a vehicle selecting module configured to select a vehicle for receiving vehicle sensor information among the plurality of vehicles in order to receive the vehicle sensor information, and request the vehicle sensor information from the selected vehicle.

In the present exemplary embodiment, the vehicle selecting module may select a vehicle considering a vehicle located at a position from which information about density of vehicles, a vehicle positioned at a blind zone, and safe driving is receivable when selecting the vehicle.

In the present exemplary embodiment, the object recognizing module may generate the object information considering at least one of a movement property, a type, a finding position, a relative distance, and finding time of each of the classified objects.

In the present exemplary embodiment, the driving condition information transmitting module may generate the object information in a form of a broadcasting message considering a band of communication with the autonomous driving vehicle, and output the generated object information in the form of the broadcasting message to the communication unit.

In the present exemplary embodiment, the traffic information collecting unit may be connected with at least one of a traffic center for collecting traffic condition information and a traffic light control device for receiving traffic light state information.

According to the embodiments of the present invention, the autonomous vehicle driving and the infrastructure for supporting autonomous driving thereof support the autonomous driving vehicle by using sensor information obtained from the infrastructure positioned outside the autonomous driving vehicle, thereby overcoming a limitation of vehicle-based autonomous driving. To this end, the autonomous driving vehicle of the present invention may improve obstacle avoidance performance, solve inaccuracy of a sensor attached to the vehicle, and decrease a frequent path setting operation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a diagram illustrating an autonomous driving system according to an exemplary embodiment of the present invention;

FIG. 2 is a diagram illustrating an autonomous driving vehicle according to an exemplary embodiment of the present invention; and

FIG. 3 is a diagram illustrating an infrastructure for supporting autonomous driving according to an exemplary embodiment of the present invention.

### DETAILED DESCRIPTION

Hereinafter, an embodiment of the present invention will be described with reference to the accompanying drawings in detail. However, the present invention is not limited to an embodiment disclosed below and may be implemented in various forms and the scope of the present invention is not limited to the following embodiments. Rather, the embodiment is provided to more sincerely and fully disclose the present invention and to completely transfer the spirit of the present invention to those skilled in the art to which the present invention pertains, and the scope of the present invention should be understood by the claims of the present invention.

The present invention provides an autonomous driving vehicle additionally utilizing infrastructure information obtained through an external infrastructure from vehicle based autonomous driving utilizing a sensor mounted in a vehicle, and an infrastructure for supporting autonomous driving thereof.

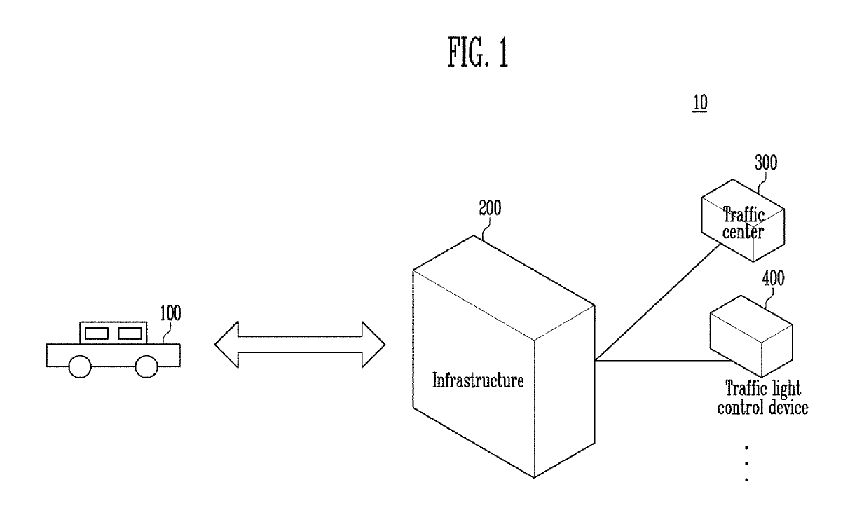

FIG. 1 is a diagram illustrating an autonomous driving system according to an exemplary embodiment of the present invention.

Referring to FIG. 1, an autonomous driving system 10 includes an autonomous driving vehicle 100, an infrastructure 200, a traffic center 300, and a traffic light control device 400.

The autonomous driving vehicle 100 includes various sensors mounted for the autonomous driving. The autonomous driving vehicle 100 recognizes a surrounding environment of the autonomous driving vehicle 100 through the mounted sensors, and controls the autonomous driving according to the recognized information.

The infrastructure 200 may communicate with the autonomous driving vehicle 100, and include various sensors for collecting information about a surrounding environment of a path which the autonomous driving vehicle 100 drives. Further, the infrastructure 200 may be connected with the traffic center 300 to collect information about a traffic condition, and may be connected with a traffic light control device 400 to collect traffic light state information.

The traffic center 300 controls so as to comprehensively recognize the traffic condition, and make a traffic condition be smooth. To this end, the traffic center 300 collects and manages traffic information for controlling a traffic condition. The traffic center 300 provides the infrastructure 200 with the collected traffic condition information.

The traffic light control device 400 is connected with various traffic lights for controlling driving of the vehicle. The traffic light control device 400 may control the connected traffic light, or collect state information about the connected traffic light. The traffic center 400 provides the infrastructure 200 with the collected state information about the traffic light.

In the meantime, the infrastructure 200 manages and provides various information for the control of the autonomous driving of the autonomous driving vehicle 100, so that it may be considered that the infrastructure includes the traffic center 300 and the traffic light control device 400.

Particularly, the infrastructure 200 of the present invention collects infrastructure-based information, for example, infrastructure sensor information collected through an internal sensor of the infrastructure 200, and traffic information collected from the traffic center 300 and the traffic light control device 400, for example, traffic condition information and traffic light state information. The infrastructure 200 collects vehicle state information collected from a preselected vehicle among a plurality of vehicles including the autonomous driving vehicle 100.

The infrastructure 200 converges the infrastructure-based information and the vehicle state information, and generates object information about objects around the autonomous driving vehicle 100 by using the converged information. The infrastructure 200 provides the autonomous driving vehicle 100 with the generated object information.

The autonomous driving vehicle 100 performs autonomous driving control by using the object information received from the infrastructure 200.

Accordingly, the autonomous driving vehicle 100 suggested in the present invention

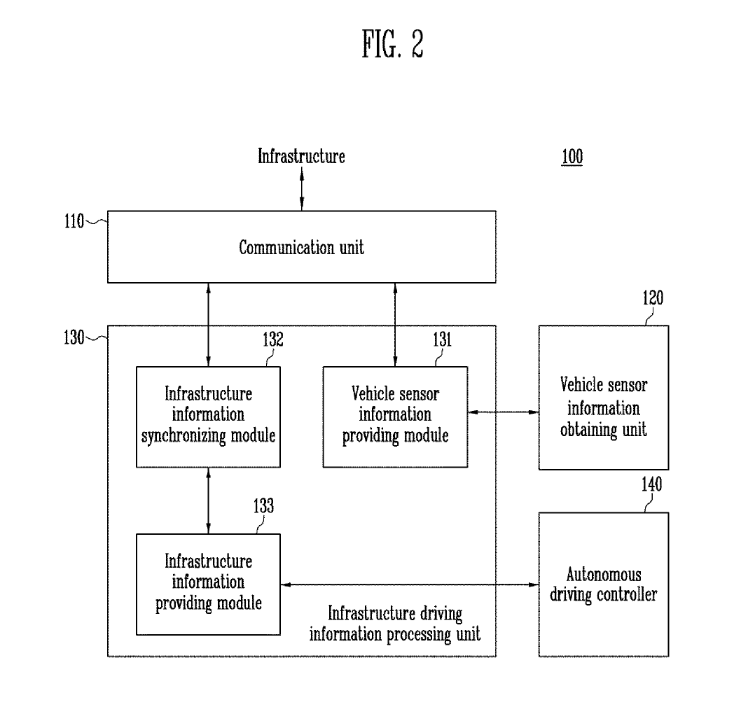

FIG. 2 is a diagram illustrating the autonomous driving vehicle according to the exemplary embodiment of the present invention.

Referring to FIG. 2, the autonomous driving vehicle 100 includes a communication unit 110, a vehicle sensor information obtaining unit 120, an infrastructure driving information processing unit 130, and an autonomous driving controller 140.

The communication unit 110 may communicate with the external infrastructure 200. The communication unit 110 processes a signal of information generated inside the autonomous driving vehicle 100 or information received through the infrastructure 200.

The vehicle sensor information obtaining unit 120 may obtain vehicle sensor information through a plurality of various attached vehicle sensors. The vehicle sensor information obtaining unit 120 may be connected to the vehicle sensors, such as a laser scanner, an image camera, a radar, and a Global Positioning System (GPS), in order to obtain surrounding information about the vehicle. The aforementioned vehicle sensors are described as examples, and the vehicle sensor information obtaining unit 120 may be connected with various vehicle sensors, in addition to the aforementioned vehicle sensors.

The vehicle sensor information obtaining unit 120 outputs the vehicle sensor information to the infrastructure driving information processing unit 130. For example, the vehicle sensor information may include surrounding information about the vehicle about an object positioned around the autonomous driving vehicle 100, an attribute (type, fix, move) of the object, or a distance between objects.

When the infrastructure driving information processing unit 130 is requested to provide the vehicle sensor information from the infrastructure 200, the infrastructure driving information processing unit 130 provides the infrastructure 200 with the vehicle sensor information through the communication unit 110. Further, the infrastructure driving information processing unit 130 receives object information obtained through convergence of the infrastructure-based information and the vehicle sensor information received from the selected vehicles through the communication unit 110.

The infrastructure driving information processing unit 130 includes a vehicle sensor information providing module 131, an infrastructure information synchronizing module 132, and an infrastructure information providing module 133.

When the vehicle sensor information providing module 131 is connected to the vehicle sensor information obtaining unit 120 and is requested to provide the vehicle sensor information from the infrastructure 200, the vehicle sensor information providing module 131 provides the infrastructure 200 with the vehicle sensor information received through the vehicle sensor information obtaining unit 120 through the communication unit 110. The vehicle sensor information providing module 131 minimize a size of data of the vehicle sensor information considering a band of communication with the infrastructure 200 and outputs the minimized vehicle sensor information to the communication unit 110.

The infrastructure information synchronizing module 132 classifies the objects included in the object information according to time and a position through the communication unit 110. The infrastructure information synchronizing module 132 maintains only newest information closest to current time based on the object information classified according to time (for example, a finding time) and a position (a position of the object). The infrastructure information synchronizing module 132 outputs the object information to the infrastructure information providing module 133.

The infrastructure information providing module 133 provides the autonomous driving controller 140 with the object information received from the infrastructure information synchronizing module 132. In the meantime, the infrastructure information providing module 133 may also provide the object information to another device or module requiring the object information.

The autonomous driving controller 140 may perform a processing operation, such as setting a path of the vehicle and driving a crossroad, by using the object information. Further, the autonomous driving controller 140 may be connected with driving devices of the autonomous driving vehicle 100, and control operations of the driving devices according to the processing operation, such as setting the path of the vehicle and driving the crossroad.

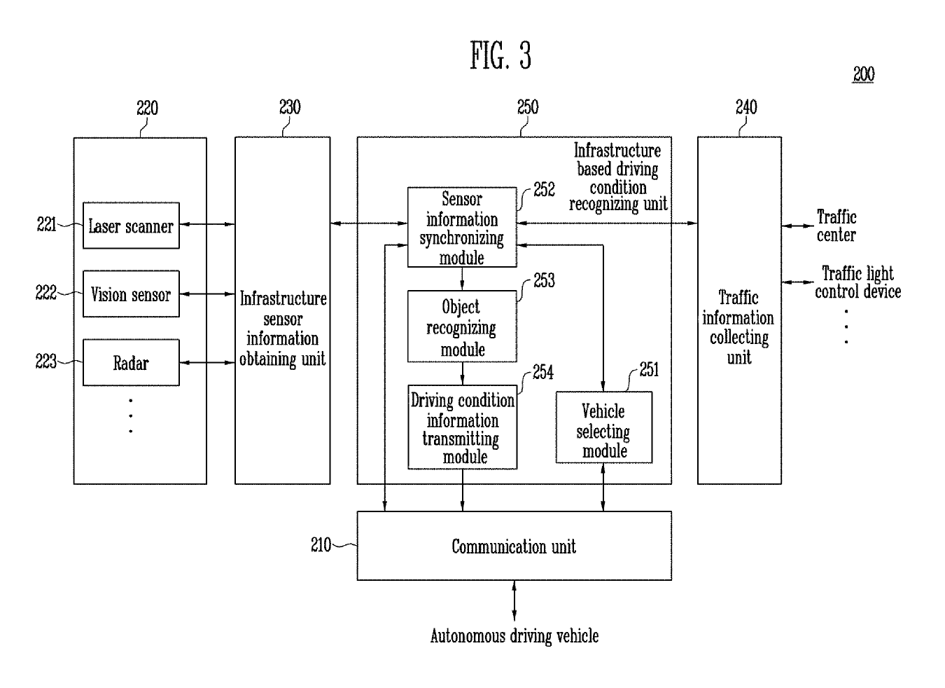

FIG. 3 is a diagram illustrating the infrastructure for supporting autonomous driving according to the exemplary embodiment of the present invention.

Referring to FIG. 3, the infrastructure 200 includes a communication unit 210, an infrastructure sensor unit 220, an infrastructure sensor information obtaining unit 230, a traffic information collecting unit 240, and an infrastructure based driving condition recognizing unit 250.

The communication unit 210 may communicate with the autonomous driving vehicle 100. Further, the communication unit 210 may communicate other vehicles, in addition to the autonomous driving vehicle 100. The communication unit 210 processes a signal of information to be transmitted to the vehicles including the autonomous driving vehicle 100 or information received from the vehicles.

The infrastructure sensor unit 220 is positioned around a road and obtains surrounding environment information through a plurality of sensors. The infrastructure sensor unit 220 includes a laser scanner 221, a vision sensor 222, a radar 223, and the like.

The infrastructure sensor unit 220 detects various information, such as a position of a driving vehicle, an obstacle, and the like on a road, necessary for the autonomous driving of the vehicle through the sensors. The Sensors 221, 222, and 223 included in the infrastructure sensor unit 220 output the detected information to the infrastructure sensor information obtaining unit 230.

The infrastructure sensor information obtaining unit 230 obtains sensor information from each of the infrastructure sensors 221, 222, and 223. The vehicle sensor information obtaining unit 230 outputs the sensor information to the infrastructure based driving condition recognizing unit 250.

The traffic information collecting unit 240 is connected with the traffic center 300 and the traffic light control device 400. The traffic information collecting unit 240 collects traffic condition information from the traffic center 300, and collects traffic light state information from the traffic light control device 400. Here, the traffic condition information includes information related to a road condition beyond a scope controlled by the infrastructure 200. The traffic information collecting unit 240 outputs traffic information, such as the collected traffic condition information or traffic light state information, to the infrastructure based driving condition recognizing unit 250.

Here, it is described based on a fact that the traffic information collecting unit 240 is directly connected with the traffic center 300 and the traffic light control device 400, but may be connected with the traffic center 300 and the traffic light control device 400 through the communication unit 210.

The infrastructure based driving condition recognizing unit 250 selects a vehicle, of which vehicle sensor information the infrastructure based driving condition recognizing unit 250 desires to receive, and receives the vehicle sensor information from the selected vehicle. The infrastructure based driving condition recognizing unit 250 synchronizes the vehicle sensor information, the infrastructure sensor information, and the traffic information. Then, the infrastructure based driving condition recognizing unit 250 generates object information based on the synchronized information, and provides the autonomous driving vehicle 100 with the generated object information through the communication unit 210.

The infrastructure based driving condition recognizing unit 250 includes a vehicle selecting module 251, a sensor information synchronizing module, an object recognizing module 253, a driving condition information transmitting module 254.

The vehicle selecting module 251 selects a vehicle for receiving the vehicle sensor information. The vehicle selecting module 251 may use various information collected by the sensor information synchronizing module 252 for selecting a vehicle. For example, the vehicle selecting module 251 selects a vehicle considering a vehicle located at a position from which the vehicle selecting module 251 may receive information about density of vehicles, a vehicle positioned at a blind zone, and other safe driving. The vehicle selecting module 251 requests the communication unit 210 to provide the selected vehicle with current vehicle sensor information collected from the vehicle through the communication unit 210.

The sensor information synchronization module 252 receives the infrastructure sensor information from the infrastructure sensor information obtaining unit 230, and receives the traffic information from the traffic information collecting unit 240. Further, the sensor information synchronization module 252 receives the vehicle sensor information received from the vehicle selected by the vehicle selecting module 251 through the communication unit 210.

The sensor information synchronization module 252 synchronizes the infrastructure sensor information, the traffic information (including the traffic condition information and the traffic light state information), and the vehicle sensor information based on time and a position. The sensor information synchronizing module 252 outputs the synchronized information to the object recognizing module 253.

The object recognizing module 253 classifies the objects based on the synchronized information received from the sensor information synchronizing module 252, and generates object information by using the classified objects. The object information includes information about a movement property of the object (whether the object is fixed or moves), the type of object, a position at which the object is found, time at which the object is found, a relative distance between the objects, and the like. The object recognizing module 253 classifies and maintains the object information based on the aforementioned information. The object recognizing module 253 outputs the object information to the driving condition information transmitting module 254.

The driving condition information transmitting module 254 receives the object information from the object recognizing module 253, and provides the autonomous driving vehicle 100 with the received object information through the communication unit 210. The driving condition information transmitting module 254 maintains only newest information closest to current time when there are overlapping objects based on the infrastructure sensor information, the traffic information, the vehicle sensor information. Accordingly, the driving condition information transmitting module 254 configures only information related to safe driving without duplication considering a limitation of a communication band and transmits the configured information to the autonomous driving vehicle 100.

To this end, the driving condition information transmitting module 254 optimizes the configuration of the object information considering a band of communication with the autonomous driving vehicle 100, and provides the autonomous driving vehicle 100 with the optimized object information in a form of a broadcasting message.

As described above, the autonomous driving system suggested in the present invention may provide the autonomous driving vehicle with the infrastructure sensor information, the traffic information, and the like obtained by the infrastructure in order to improve a driving environment recognizing range and reliability of the vehicle even in a complex road environment, such as a crossroad, through the support of the infrastructure. Accordingly, the autonomous driving system suggested in the present invention may obtain information related to the autonomous driving through the infrastructure, thereby obtaining more various information compared to that of a vehicle based autonomous driving system.

Further, the autonomous driving vehicle of the present invention may receive complex road environment information or driving condition information beyond a sensor range (short distance) of the vehicle, thereby improving driving stability of the autonomous driving vehicle and minimizing the number of times of an operation of setting a driving path.

To this end, the infrastructure of the present invention converges infrastructure sensor information from the sensor connected to the infrastructure, traffic information (traffic condition information and traffic light state information), and vehicle sensor information from designated vehicles and provides the autonomous driving vehicle with the converged information in order to provide complex road environment information or driving condition information beyond a short distance.

Surrounding information about the vehicle output from the infrastructure suggested in the present invention may be utilized for support of safe driving, support of driver's convenience, control of an unmanned vehicle, and the like.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. An autonomous driving vehicle, comprising:
a communication unit configured to communicate with an infrastructure;
a vehicle sensor information obtaining unit configured to obtain vehicle sensor information;
an infrastructure driving information processing unit configured to provide the infrastructure with the vehicle sensor information through the communication unit when the vehicle sensor information is requested, and receive vehicle sensor information from a vehicle pre-selected by the infrastructure and object information generated based on information based on the infrastructure from the infrastructure through the communication unit; and
an autonomous driving unit configured to receive the object information to control autonomous driving.

2. The autonomous driving vehicle of claim 1, wherein the infrastructure driving information processing unit includes:
a vehicle sensor information providing module configured to receive a vehicle sensor information request from the infrastructure, and provide the vehicle sensor information according to the vehicle sensor information request;
an infrastructure information synchronizing module configured to receive the object information, classify the object information according to time and a position, and maintain newest updated information; and
an infrastructure information providing module configured to provide the autonomous driving unit with the object information.

3. The autonomous driving vehicle of claim 2, wherein the infrastructure information synchronizing module classifies the object information according to the time and the position, and maintains only newest information closest to current time based on the object information classified according to the time and the position.

4. The autonomous driving vehicle of claim 1, wherein the information based on the infrastructure includes traffic information and infrastructure sensor information, and
the traffic information includes traffic condition information obtained through a traffic center and traffic light state information obtained through a traffic light control device, and the infrastructure sensor information includes information obtained by sensing surrounding environments of sensors connected with the infrastructure.

5. An infrastructure for supporting autonomous driving of an autonomous driving vehicle, comprising:
a communication unit configured to communicate with a plurality of vehicles;
an infrastructure sensor information obtaining unit configured to obtain infrastructure sensor information obtained by sensing surrounding environments from a plurality of infrastructure sensors;
a traffic information collecting unit configured to collect traffic information; and
an infrastructure based driving condition recognizing unit configured to receive vehicle sensor information from a selected vehicle through the communication unit, synchronize the vehicle sensor information, the infrastructure sensor information, and the traffic information, and then provide the autonomous driving vehicle with object information generated based on the synchronized information through the communication unit.

6. The infrastructure of claim 5, wherein the plurality of sensors includes at least one of a laser scanner, a vision sensor, and a radar.

7. The infrastructure of claim 5, wherein the infrastructure based driving condition recognizing unit includes:
a sensor information synchronizing module configured to synchronize the vehicle sensor information, the infrastructure sensor information, the traffic information based on time and a position;
an object recognizing module configured to classify objects by using the synchronized information and generate object information by using the classified objects; and
a driving condition information transmitting module configured to provide the autonomous driving vehicle with the object information through the communication unit.

8. The infrastructure of claim 7, wherein the infrastructure based driving condition recognizing unit further includes a vehicle selecting module configured to select a vehicle for receiving vehicle sensor information among the plurality of vehicles in order to receive the vehicle sensor information, and request the vehicle sensor information from the selected vehicle.

9. The infrastructure of claim 8, wherein the vehicle selecting module selects a vehicle considering a vehicle located at a position from which information about density of vehicles, a vehicle positioned at a blind zone, and safe driving is receivable when selecting the vehicle.

10. The infrastructure of claim 7, wherein the object recognizing module generates the object information considering at least one of a movement property, a type, a finding position, a relative distance, and finding time of each of the classified objects.

11. The infrastructure of claim 7, wherein the driving condition information transmitting module generates the object information in a form of a broadcasting message considering a band of communication with the autonomous driving vehicle, and outputs the generated object information in the form of the broadcasting message to the communication unit.

12. The infrastructure of claim 5, wherein the traffic information collecting unit is connected with at least one of a traffic center for collecting traffic condition information and a traffic light control device for receiving traffic light state information.
